(19) United States
(12) Patent Application Publication
(10) Pub. No.: US 2008/0216440 A1
(43) Pub. Date: Sep. 11, 2008

(54) JOINT CONSTRUCTION, FITTING AND MANUFACTURING PROCESS OF FITTING

(75) Inventor: Isao Kobayashi, Tokyo (JP)

Correspondence Address: DARBY & DARBY P.C., P.O. BOX 770, Church Street Station, New York, NY, 10008-0770, US

(73) Assignee: YKK AP INC., Tokyo (JP)

(21) Appl. No.: 12/043,257

(22) Filed: Mar. 6, 2008

(30) Foreign Application Priority Data
Mar. 7, 2007 (JP) 2007-057662

(51) Int. Cl. E06B 1/12; F16B 11/00; B21D 39/00; B23P 11/00; E04C 2/38

(52) U.S. Cl. 52/656.6; 403/295; 29/510

(57) ABSTRACT

Since an inside piece of a joint block is abutted to a rib of a second opposed piece under a pressure by engaging a first opposed piece of a frame member with the joint block, the inside piece can be securely abutted at the position of the rib even when the second opposed piece and the joint block are slightly deformed, which secures a predetermined joint intensity by preventing a variation of the abutment position. Since the joint block is abutted with the rib, the pressure per a dimension can be more increased than abutting with the whole surface of the inside piece, which consequently increases the frictional force to improve the joint intensity.

### BACKGROUND OF THE INVENTION

1. Field of the Invention

The present invention relates to a joint construction, a fitting and a manufacturing process of the fitting. More specifically, it relates to a joint construction, a fitting and a manufacturing process of the fitting, which cramp jointed portions under the condition where a joint is placed bridging a pair of the jointed portions such as frame members so that the jointed portions are jointed with each other.

2. Description of Related Art

Conventionally, jointing methods (miter joint) such as cramping and pinning are applied to connect end portions of frame members of window frames, sash frames and the like which are formed by assembling frame members (rail members). In the above, longitudinal distal ends of frame members that are connected with each other are cut at a certain angle (for example, 45 degrees) so that a joint (such as a joint block and a bracket) that bridges the frame members can be inserted. Then, the frame members are cramped or pinned from outside to engage the distal ends with the joint to joint the frame members under the condition where the distal ends are abutted to each other. Jigs to be used for this jointing method are suggested (for example, see Japanese Patent Publication No. 3086381).

By the way, in a conventional joint construction, an inner surface (of the opposite side of the cramped side) of the frame member engaged by cramping or pinning and a surface of the joint are pressed to be abutted so that a joint intensity can be obtained by the frictional force therebetween. Therefore, surface contact of the frame member and the joint is required to keep a certain joint intensity. However, deformation derived from the manufacturing process is more or less generated on the surfaces of the frame member and the joint. For example, when the surfaces are not fully contacted at an engaged position but contacted only at portions largely deflected from the engaged position (since there is a gap in-between), surface contact of the frame member and the joint becomes insufficient, which results in insufficient frictional force and joint intensity causing shakiness and a gap between frame members.

Further, the inner surface of the frame member is sometimes flexed by pressing force of jigs when the frame member is engaged with the joint. In this case, if the pressing force of jigs is released after the engagement, the flexure is canceled releasing the pressing force. The surface contact of the frame member and the joint becomes accordingly insufficient so that enough frictional force cannot be kept.

### SUMMARY OF THE INVENTION

An object of the present invention is to provide a joint construction that secures a predetermined joint intensity by a relatively simple construction, a fitting and a manufacturing method.

A joint construction according to an aspect of the present invention joints jointed portions with each other by engaging a pair of the jointed portions with a joint bridging the pair of the jointed portions, in which each of the pair of the jointed portions includes at least a first opposed piece and a second opposed piece which oppose with each other sandwiching the joint, the first opposed piece is engaged with the joint to face the second opposed piece and at least one of an inner surface of the second opposed piece and an outer surface of the joint which is opposed to the inner surface is provided with a projection that projects towards the other.

The jointed portion may be frame members (frame members of a window frame, rail members of a sash, a backband and the like), members used for various architectural materials such as interior materials and exterior materials and further several constructional materials, decorative materials and the like used for anything other than fittings, architectural materials and the like. Briefly, the present invention can be broadly applied to joint constructions that joint a pair of jointed portions with each other by cramping or pinning using a joint.

According to the present invention above, since the projection is provided on at least one of the inner surface of the second opposed piece of the jointed portion and the outer surface of the jointed portion, the pressing force generated when the projection is engaged with the first opposed piece on the opposite side sandwiching the joint is applied on the projection via the joint so that the projection can be abutted either with the joint or the second opposed piece under a pressure. Accordingly, even when the second opposed piece and the joint are slightly deformed, both abutted positions can be limited to the projection. Therefore, a variation of the contact position is prevented so that the frictional force expected by the design can be obtained to secure a predetermined joint intensity. Further, since the abutment position is limited to the projection, the pressure per dimensions can be increased to improve the joint intensity.

Further, since the abutment position of the second opposed piece and the joint is limited to the projection, flexure of the second opposed piece and the joint generated upon the engagement can be also prevented by properly setting the number and position of the projection. Consequently, application failure of the pressing force is restricted to secure the joint intensity. Especially, if the projection is formed on the inner surface of the second opposed piece, the rigidity of the second opposed piece itself is increased to effectively suppress the flexure.

In the above, the pair of the jointed portions may be preferably a pair of elongated frame members jointed with each other by a predetermined crossing angle and the frame members include a hollow portion or an open cross-section whose two sides are formed by the first opposed piece and the second opposed piece, the joint being inserted to the hollow portion or the open cross-section.

According to the above, since the frame members include the hollow portion and an open cross-section (for example, C-shaped) where the joint is inserted, the rigidity of the frame members is increased so that the flexure upon the engagement is prevented. Further, since the joint inserted in the hollow portion is not exposed outside, visual appearance after being jointed can be made favorable as a product.

According to the above, since the projection is constituted by the projected tread along the longitudinal direction of the frame members, the projected tread can be integrally formed upon the molding material manufacturing when the frame member is made from a molding material (aluminum) molded by extrusion, which facilitates the manufacturing compared to forming the projected tread afterward. In addition, since the projected tread extrudes along the longitudinal direction of the frame members, the projected tread and the joint can be securely abutted with each other to secure the joint intensity even when the engaged position is slightly shifted in the longitudinal direction.

In the above, the number of the projected tread may be preferably one and a position where the first opposed piece is engaged with the joint is, on a cross section orthogonally crossing the longitudinal direction of the frame member, any one of a single first position substantially opposed to the projected tread, two positions equidistant from each other sandwiching the first position that is opposed to the projected tread and three positions comprising the first position substantially opposed to the projected tread and the two positions equidistant from each other sandwiching the first position.

In the above, two projected treads may be preferably provided and the first opposed piece is engaged with the joint at, on a cross section orthogonally crossing the longitudinal direction of the frame member, any one of: a single first position opposed to a substantially middle position of the two projected treads, two positions respectively opposed to the two projected treads and three positions comprising the two positions respectively substantially opposed to the two projected treads and the first position opposed to the substantially middle position of the two projected treads.

In the above, three projected treads may be preferably provided and the first opposed piece is engaged with the joint at, on a cross section orthogonally crossing the longitudinal direction of the frame member, any one of two positions respectively opposed to substantially middle positions of two neighboring projected treads of the three projected treads and three positions respectively opposed to the three projected treads.

According to the above, a desired joint intensity can be secured by setting the appropriate number of projected treads and the engaged positions according to the design condition such as the size of the frame members and the withstand load.

A fitting according to another aspect of the present invention has: a frame body assembled by jointing the frame members with each other by the joint construction mentioned above; and a surface member supported inside the frame body, in which the first opposed piece on the frame member is placed on an outside of a width direction with respect to the second opposed piece.

According to the above, the combination of the frame body and the surface member may be the one of: a fitting frame such as a window frame as the frame body and a sash (a movable sash, a fixed sash) as the surface member; a window frame and the like as the frame body and a panel material such as a glass panel as the surface member; and further a sash frame (a rail) as the frame body and a panel material as the surface member. In other words, the fitting of the present invention can be applied in any form such as a window and a door with a variety of way of opening and closing or a fixed window that can not be opened and closed.

According to the above fitting, while substantially the same advantages as the before-mentioned joint construction can be obtained, joint operations (cramping and pinning) can be easily done since the first opposed piece is on the outside of the width direction relative to the second opposed piece (i.e. the engaged position is provided on the outer circumferential side of the frame body). Therefore, the pressing force of the engagement can be oriented towards the direction where distal ends of the frame members are closely contacted, which properly prevents the generation of shakiness and gaps between frame members.

A manufacturing method of a fitting according to still another aspect of the present invention has a frame body assembled by jointing a plurality of frame members with each other and a surface member supported inside the frame body, the method including: forming the frame members in a rectangular shape, the frame members comprising at least a first opposed piece and a second opposed piece opposed to each other; providing a joint which can be inserted between the first opposed piece and the second opposed piece bridging the frame members; providing a projection on at least any one of an inner surface of the second opposed piece and an outer surface of the joint which is opposed to the inner surface, the projection projecting towards the other; abutting distal ends of a pair of the frame members with each other while the joint is placed bridging the pair of the frame members jointed with each other; and abutting the projection to the other of the inner surface of the second opposed piece and the outer surface of the joint so as to joint the pair of the frame members with each other while engaging the first opposed piece with the joint to oppose to the second opposed piece.

According to the above manufacturing method, substantially the same advantages as the before-mentioned joint construction (i.e. the projection and the joint or the second opposed piece can be abutted with each other by the pressing force) can be obtained. In other words, by limiting the abutment position onto the projection, a variation of the contact position is prevented and the designed frictional force can be obtained even when the second opposed piece and the joint are slightly deformed. Further, since the abutment position is limited onto the projection, pressing force per dimensions is increased to enhance the frictional force. Consequently, while improving the joint intensity, the flexure of the second opposed piece and the joint upon the engagement can be suppressed by properly setting the number and the position of the projections so that application failure of the pressing force can be prevented to secure the joint intensity.

### BRIEF DESCRIPTION OF THE DRAWINGS

FIG. 1 is a front view showing a fitting according to an embodiment of the present invention.

FIG. 2A is an enlarged cross-sectional view showing a part of the fitting.

FIG. 2B is an enlarged cross-sectional view showing another part of the fitting.

FIG. 3 is a cross-sectional view showing a manufacturing process of the fitting.

FIG. 4A is a cross-sectional view showing a combination of an engaged position and a projection on the fitting.

FIG. 4B is a cross-sectional view showing another combination of the engaged position and the projection on the fitting.

FIG. 4C is a cross-sectional view showing a further combination of the engaged position and the projection on the fitting.

FIG. 5A is a cross-sectional view showing a combination of the engaged position and the projection of the fitting.

FIG. 5B is a cross-sectional view showing another combination of the engaged position and the projection on the fitting.

FIG. 5C is a cross-sectional view showing a further combination of the engaged position and the projection on the fitting.

FIG. 6A is a cross-sectional view showing a combination of the engaged position and the projection on the fitting.

FIG. 6B is a cross-sectional view showing another combination of the engaged position and the projection on the fitting.

FIG. 7 is a cross-sectional view showing a modification of the embodiment.

FIG. 8 is a cross-sectional view showing another modification of the embodiment which is different from that in FIG. 7.

FIG. 9A is a cross-sectional view showing another modification of the embodiment which is different from those in FIGS. 7 and 8.

FIG. 9B is a cross-sectional view showing another modification of the embodiment which is different from those in FIGS. 7 and 8.

FIG. 10 is a cross-sectional view showing another modification of the embodiment which is different from those in FIGS. 7-9.

### DETAILED DESCRIPTION OF PREFERRED EMBODIMENT(S)

An embodiment of the present invention will be described below with reference to the accompanying drawings.

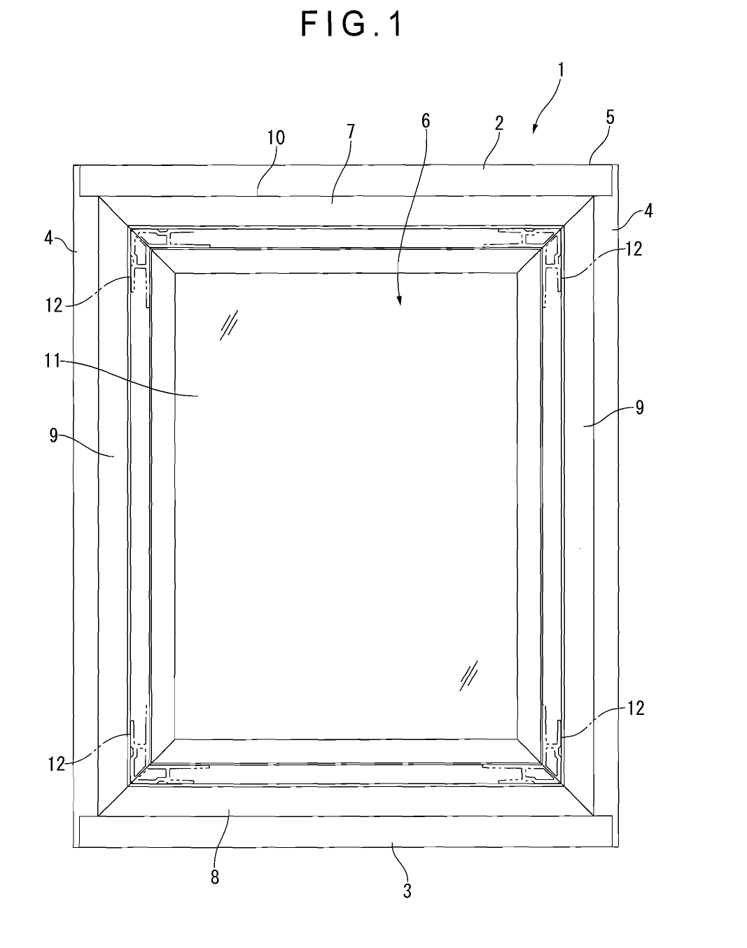

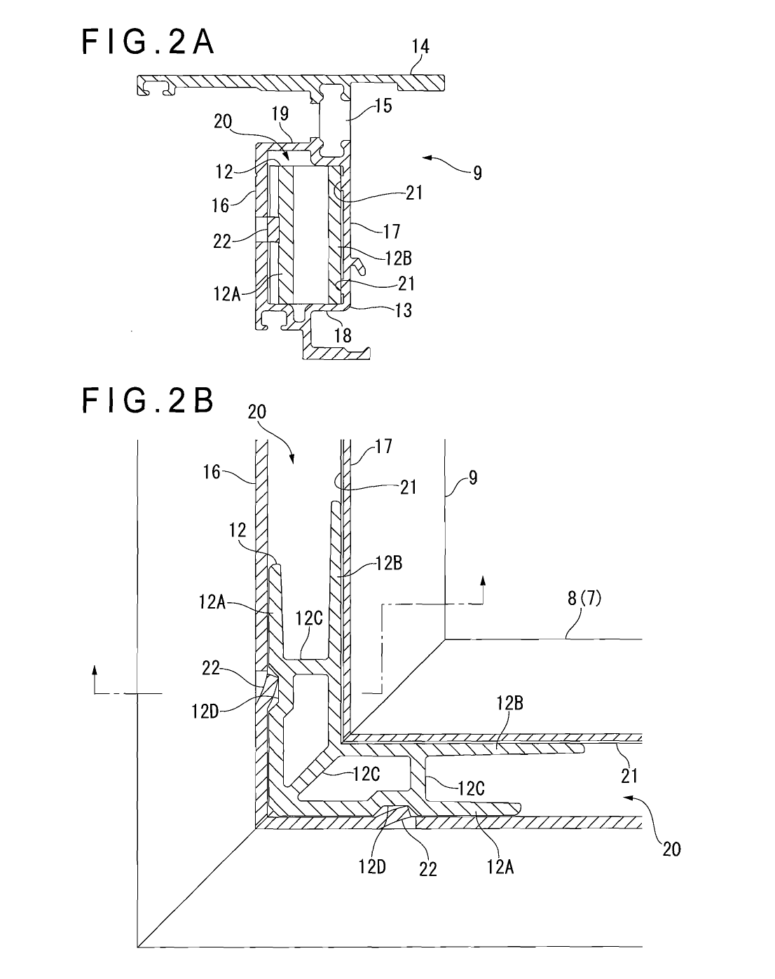

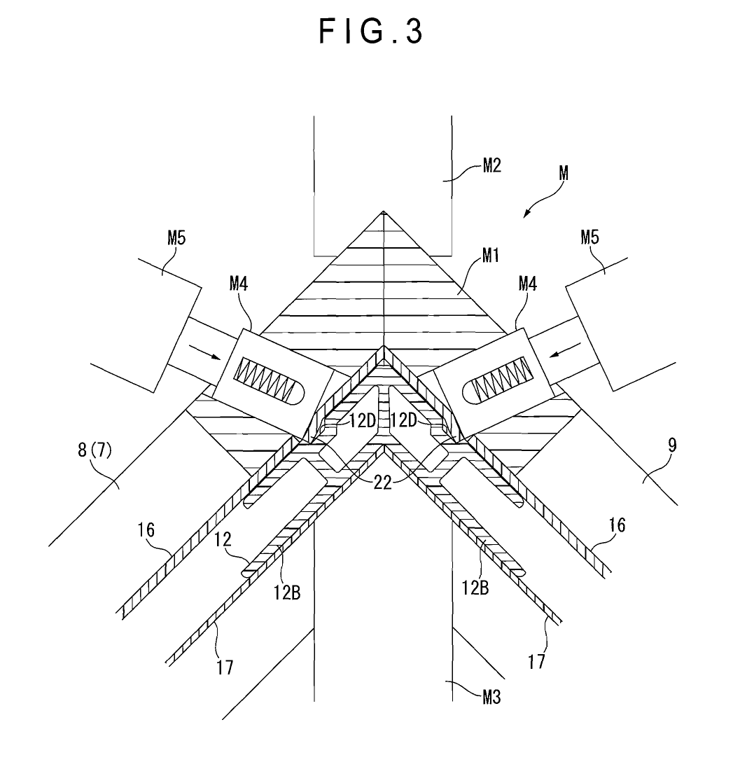

FIG. 1 is a front view showing a sash window 1 (a fitting) according to the embodiment of the present invention. FIGS. 2A and 2B are enlarged cross-sectional views showing a part of a sash 6 of the sash window 1. FIG. 3 is a cross-sectional view showing a manufacturing process of the sash 6.

In FIGS. 1, 2A and 2B, the sash window 1 includes a window frame 5 assembled with an upper frame 2, a lower frame 3 and left and right vertical frames 4, and the sash 6 movably supported at the inside of the window frame 5. The sash 6 includes a sash frame 10 (a frame) assembled with a top rail 7, a bottom rail 8 and left and right vertical rails 10 and a glass panel 11 (a surface member) fitted to be supported at the inside of the sash frame 10. The window frame 5 is assembled by screws nailed from the outside of the vertical frames 4 under the condition where the upper frame 2 and the lower frame 3 are between depth pieces of the right and left vertical frames 4. On the other hand, the sash frame 10 is assembled by miter joint that cramps each rail member under the condition where the longitudinal distal ends of each of rail members (the upper rail 7, the lower rail 8, the vertical frames 9) that are of frame members are cut at 45 degrees angle so that a joint block 12 (a joint that bridges rail members) is inserted thereinto with the cut ends of the rail members (butt end) being directly faced to each other.

Each of the rail members (the upper rail 7, the lower rail 8, the vertical rails 9) of the sash frame 10 includes, as shown in FIGS. 2A and 2B, an interior member 13 and an exterior member 14 made of aluminum and a heat insulating member 15 made of resin which connects the interior member 13 and the exterior member 14. The interior member 13 of each of the rail members includes a pair of a first opposed piece 16 and a second opposed piece 17 which are opposed with each other and a hollow portion 20 formed by a pair of a width piece 18 and a width piece 19 which connect the first opposed piece 16 and the second opposed piece 17. The first opposed piece 16 is provided on the outside of the width direction with respect to the second opposed piece 17. Two ribs (projected treads) 21 (projections projected towards the first opposed piece 16) are consecutively formed on the inner surface of the second opposed piece 17 (i.e. the surface opposed to the first opposed piece 16) in the longitudinal direction of each of the rail members. On each of the rail members, a cramping portion 22 cramps the first opposed piece 16 from the outside of the width direction towards the second opposed piece 17.

The joint block 12 is inserted in the hollow portion 20 of each of the rail members. The joint block 12 is an integral part made from metal and formed in substantial L-shape as a whole. The joint block 12 is provided with an outside piece 12A placed along the inner surface of the first opposed piece 16, an inside piece 12B placed along the inner surface of the second opposed piece 17 and an connecting piece 12C that connects the outside piece 12A and the inside piece 12B. Further, a dent 12D is formed on the outer surface that corresponds to the cramping portion 22 on the outside piece 12A, which is engaged with the cramping portion 22 to restrict the relative movement of the rail members and the joint block 12. In addition, the outer surface of the inside piece 12B (the surface on the side of the second opposed piece 17) of the joint block 12 is formed flat so as to abut with the rib 21 by a predetermined pressure when the first opposed piece 16 is cramped.

Next, a joint process of the frame members (the top rail 7, the bottom rail 8, the vertical rails 9) will be described with reference to FIG. 3.

A joint device M consists of a positioning jig M1 set from the outside on the external corner of the cross position of a pair of rail members (the bottom rail 8 and the vertical rails 9 or the top rail 7 and the vertical rails 9) that joint with each other, a first fixing component M2 that presses the positioning jig M1 towards the cross position of the rails, a second fixing component M3 set from the inside on the internal corner of the cross position of the rail members, a pair of cramping claws M4 that cramp the first opposed piece 16 of the rail members with being guided by the positioning jig M1 and a cylindrical press M5 that advances and retracts the cramping claw M4 to be pressed towards the first opposed piece 16. The positioning jig M1 is provided with a guiding groove that guides the advancing and retracting of the clamping claw M4.

The joint process using the above joint device M is as follows. Firstly, the bottom rail 8 (or the top rail 7) and the vertical rails 9 whose longitudinal distal ends are cut at 45 degree and the joint block 12 are prepared so that the joint block 12 is inserted into the hollow portions 20 of the bottom rail 8 and the vertical rails 9 and the distal ends of the bottom rail 8 and the vertical rails 9 are fitted with each other.

Next, the positioning jig M1 of the joint device M is set from outside on the external corner of the cross position of the bottom rail 8 and the vertical rails 9. Then, the first fixing component M2 is set on the positioning jig M1 and the second fixing component M3 is abutted with the second opposed piece 17 from inside on the internal corner of the cross position to be set. By pressing the first fixing component M2 and the second fixing component M3 in a direction where the first fixing component M2 and the second fixing component M3 come closer to each other under the above condition, the positioning jig M1 is prevented from moving and the distal ends of the fitted bottom rail 8 and vertical rails 9 are positioned without misalignment. Then, the cramping claw M4 is inserted in the guiding groove of the positioning jig M1. The press 5 is set on each of the cramping claws M4.

Once it is prepared for cramping as above, a pair of the cramping claws M4 are simultaneously pressed towards the first opposed piece 16 by a spring of the press M5 so that the cramping portion 22 of the first opposed piece 16 is deformed inward to be engaged with the dent 12D of the joint block 12. Then, the cramping portion 22 is pressed by the pressure of the cramping claw M4 so that the outer surface of the inside piece 12B of the joint block 12 is abutted with the rib 21 of the second opposed piece 17 by a predetermined pressure.

The pressure of the press M5 is released to retract the cramping claw M4 after the cramping portion 22 and the joint block 12 are engaged with each other and the joint block 12 is abutted with the rib 21 as above. After that, the first fixing component M2, the second fixing component M3 and the positioning jig M1 are removed to finish the joint operation.

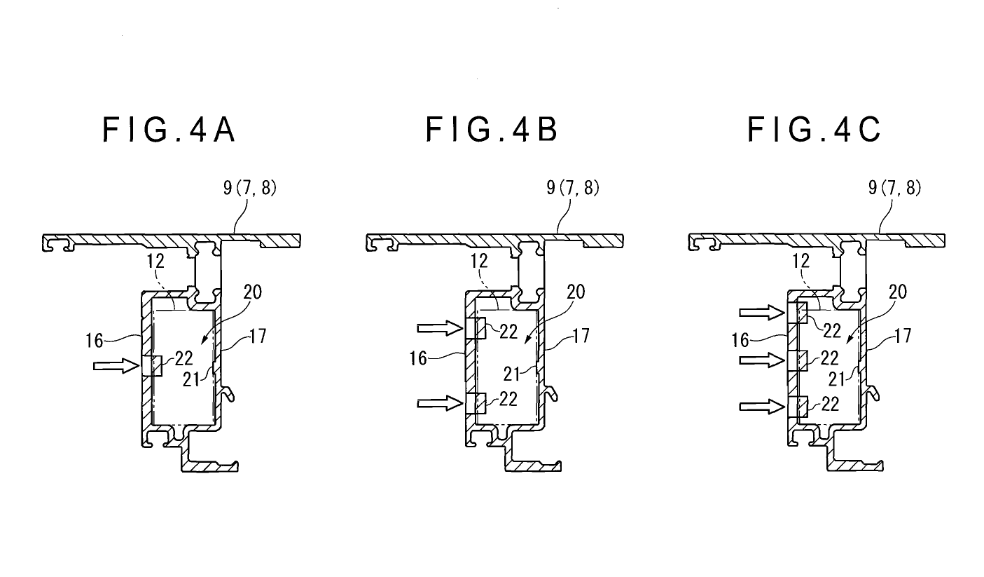

Next, relations between positions (and the number) of the cramping portions 22 and positions (and the number) of the ribs 21 of the second opposed piece 17 will be described with reference to FIGS. 4A-6B.

FIGS. 4A-4C, 5A-5C, 6A and 6B are cross-sectional views showing variations of combinations of cramping positions and the ribs (projected treads).

Although some combinations of the number of positions of the cramping portions 22 and the number of ribs 21 in the present embodiment are shown as FIGS. 4A-6B as examples, arrangements of the cramping portions and the projections are not limited to those shown in FIGS. 4A-6B but can be set at any positions and the numbers. Further, although cross sections of a specific level that relates to the longitudinal direction of rails are shown in FIGS. 4A-6B, cramping positions to cramp the first opposed piece 16 may be provided at plural levels along with the longitudinal direction of rail members.

In FIGS. 4A-4C, a single rib 21 is formed on the substantial center in the depth direction of the second opposed piece 17 of the rail members (the top rail 7, the bottom rail 8, the vertical rails 9). In FIG. 4A, in response to the single rib 21, one cramping portion 22 is set at a first position of the first opposed piece 16, which is substantially opposed to the single rib 21 in the width direction. Further, two cramping portions 22 are set at two positions one by each, which are substantially equidistant in the depth direction sandwiching the first position on the first opposed piece 16 which is opposed to the single rib 21 in the width direction. Further, in FIG. 4C, three cramping portions 22 are provided at three positions one by each, the three positions including: the first position on the first opposed piece 16 substantially opposed to the rib 21 in the width direction; and two positions substantially equidistant in the depth direction sandwiching the position on the first opposed piece 16 which is opposed to the rib 21 in the width direction.

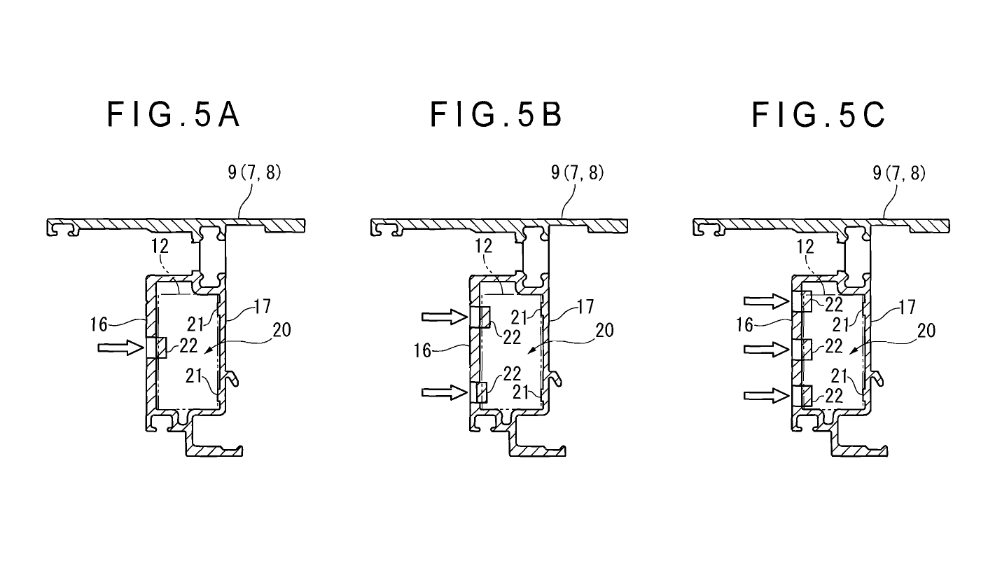

In FIGS. 5A-5C, on the second opposed piece 17 on the rail members (the top rail 7, the bottom rail 8, the vertical rails 9), two ribs 21 are formed at two distant positions one by each, which includes one position on the interior side of the depth direction of the second opposed piece 17 and the other position on the exterior side of the depth direction of the second opposed piece 17. In FIG. 5A, in response to the two ribs 21, the cramping portion 22 is provided at one position on the first opposed piece 16 opposed to the substantial middle position of the two ribs 21. In FIG. 5B, two cramping portions 22 are provided at two positions on the first opposed piece 16 one by each, which are respectively opposed to the two ribs 21 in the width direction. Further, in FIG. 5C, three cramping portions 22 are provided at three positions one by each, which include: one on the first opposed piece 16 substantially opposed to the substantial middle position of the two ribs 21; and two on the first opposed piece 16 which are respectively opposed to the two ribs 21 in the width direction.

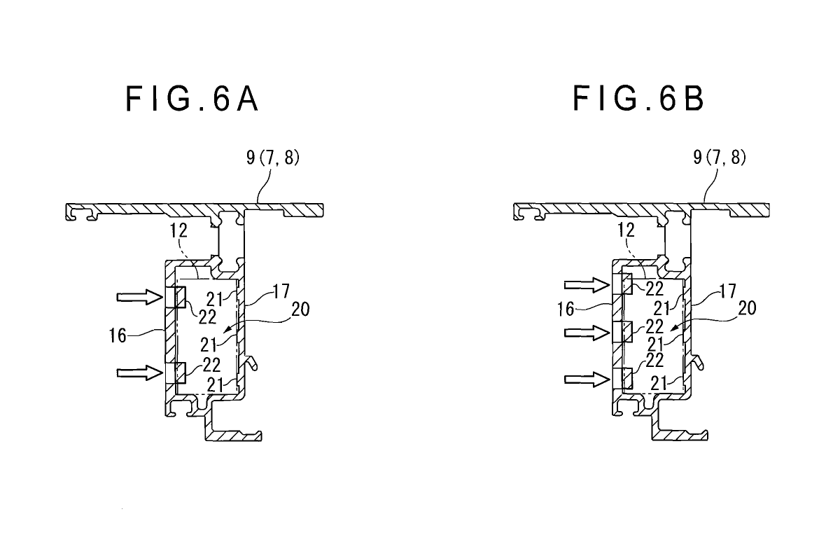

Next, In FIGS. 6A and 6B, on the second opposed piece 17 of the rail members (the top rail 7, the bottom rail 8, the vertical rails 9), three ribs 21 are formed on three distant positions one by each, which include: one in the substantial center in the depth direction of the second opposed piece 17; another one on the interior side of the depth direction of the second opposed piece 17; and the other on the exterior side of the depth direction of the second opposed piece 17. In FIG. 6A, in response to the three ribs 21, two cramping portions 22 are provided at two positions on the first opposed piece 16 one by each, which are opposed to the substantial middle positions of the neighboring two ribs 21. In FIG. 6B, three cramping portions 22 are provided at three positions on the first opposed piece 16 one by each, which are respectively opposed to the three ribs 21 in the width direction.

As shown in FIGS. 4A-6B, when the number of the cramping portion 22 is increased, the joint intensity is accordingly increased corresponding to the number. However, since the pressure that presses the joint block 12 is also accordingly increased, the number of ribs 21 which corresponds to the required joint intensity and pressure is formed to set the pressing force per each rib 21 in a proper range.

According to the present embodiment, the following advantages can be enjoyed.
(1) Since the rib 21 of the second opposed piece 17 and the inside piece 12B of the joint block 12 are abutted with each other under the pressure by cramping the first opposed piece 16, the rib 21 of the second opposed piece 17 and the inside piece 12B of the joint block 12 can be surely abutted at the position of the rib 21 even when the second opposed piece 17 or the joint block 12 are slightly deformed, which secures a predetermined joint intensity by preventing variations of the contact position.
(2) Since the joint block 12 is abutted with the rib 21, the pressure per dimensions can be more increased than abutting with the whole surface of the inside piece 12B, which consequently increases the frictional force to improve the joint intensity. Further, since the 25 abutment position is limited to the rib 21, flexure of the second opposed piece 17 generated by cramping can be also restrained by properly setting the number and position of the rib 21. Consequently, the release of the pressing force is prevented to secure the joint intensity. In addition, since the rib 21 is formed on the second opposed piece 17, the rigidity of the second opposed piece 17 itself is increased to effectively suppress the flexure.
(3) Since each rail member (the top rail 7, the bottom rail 8, the vertical rails 9) includes the hollow portion 20 where the joint block 12 is inserted, the rigidity of the rail member is increased so that flexure upon cramping is prevented. Further, since the joint block 12 inserted in the hollow portion 20 is not exposed to the outside, visual appearance of the sash window 1 can be made favorable.

(4) By cramping the first opposed piece 16 placed on the outside of the width direction with respect to the second opposed piece 17, cramping operation can be easily done and cramping pressure can be imposed in the direction where distal ends of the rail members are closely contacted so that shakiness and gaps between rail members can be properly prevented.

The scope of the present invention is not limited to the above embodiment(s) but includes following modifications as long as an object of the present invention can be achieved.

For example, the sash window I as a fitting was presented as an example in the above embodiment, however, the joint construction of the present invention is not limited to the one applied to the sash window I but can be applied to various fittings such as interior and exterior materials and the like. When the joint construction of the present invention is applied to the sash window, not only the rail members (the top rail 7, the bottom rail 8, the vertical rails 9) of the sash 6 as shown in the above embodiment but also the frame members (the upper frame 2, the lower frame 3, the vertical frames 4) of the window frame 5 may be jointed by the joint construction of the present invention. Further, both of the frame members of the window frame 5 and the rail members of the sash 6 may be jointed by the joint construction of the present invention.

In addition, in the above embodiment, although the rail members (the top rail 7, the bottom rail 8, the vertical rails 9) are jointed at 90 degrees crossing angle (i.e. distal ends of the rail members are cut at 45 degrees to be contacted with each other), the joint angle of the rail members and frame members is not limited to 90 degrees and the cutting angle of the distal ends of the rail members and frame members is not limited to 45 degrees either. In other words, the frame bodies formed by the joint construction of the present invention is not limited to the one that is rectangular as a whole but may be the one that is triangular and multangular of more than pentagonal. Further, when the width dimensions of the frame members jointed together are different, the cutting angles of each of the frame members may be accordingly configured.

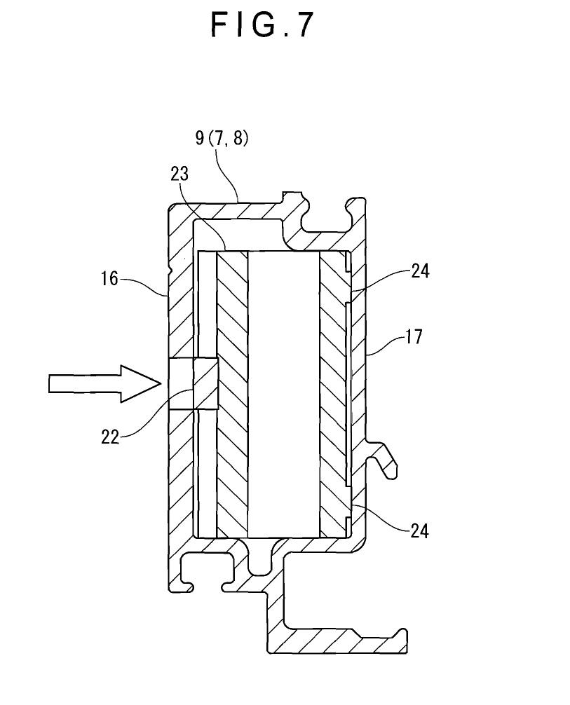

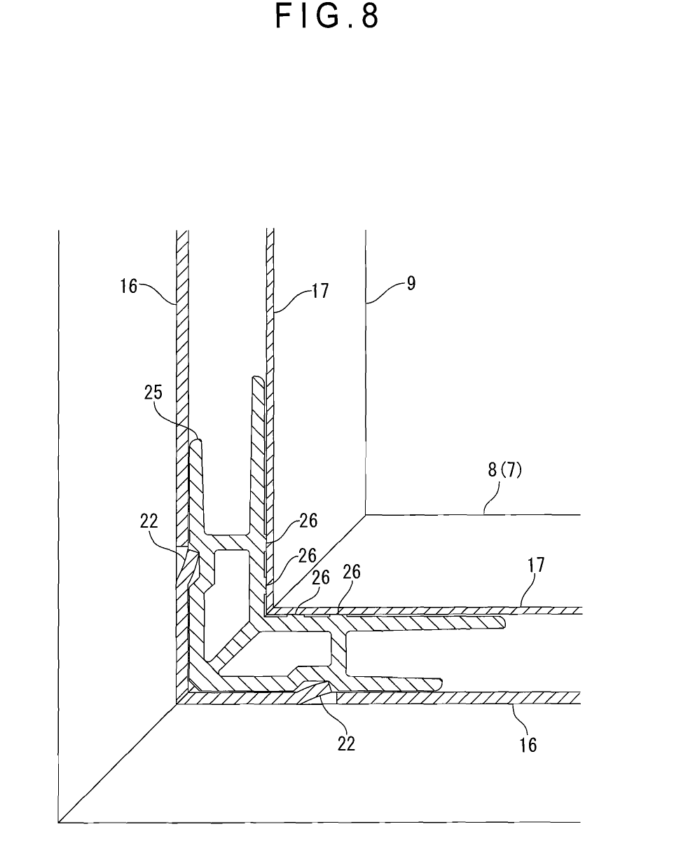

In addition, the rib 21 is formed as a projection on the second opposed piece 17 of the rail members in the above embodiment, the projection may be provided on the side of the joint (the joint block 12) as shown in FIGS. 7 and 8.

Specifically, two ribs 24 that project towards the second opposed piece 17 of the rail members (the top rail 7, the bottom rail 8, the vertical rails 9) are formed on a joint block 23 shown in FIG. 7. The two ribs 24 are formed along the longitudinal direction of the rail members as well as the rib 21 of the above embodiment. When the first opposed piece 16 is cramped, the two ribs 24 are abutted with the second opposed piece 17 by the pressing force.

On a joint block 25 shown in FIG. 8, two ribs 26 that project towards the second opposed piece 17 are formed on each of a pair of the rail members (the bottom rail 8 and the vertical rails 9 or the top rail 7 and the vertical rails 9). These ribs 26 abut with the second opposed piece 17 by the pressing force generated by cramping the first opposed piece 16. However, the rib 26 is formed crossing the longitudinal direction of the rail members unlike the rib 21 of the above embodiment. Such a joint block 25 is manufactured by cutting a material elongated by extrusion which has a cross-section shown in FIG. 8. Since the rib 26 is formed along the extruded direction, the rib 26 can be relatively easily provided. Further, since the rib 26 that crosses the longitudinal direction of the rail members abuts against the second opposed piece 17, slipping-out of the joint block 25 from the rail members can be effectively prevented.

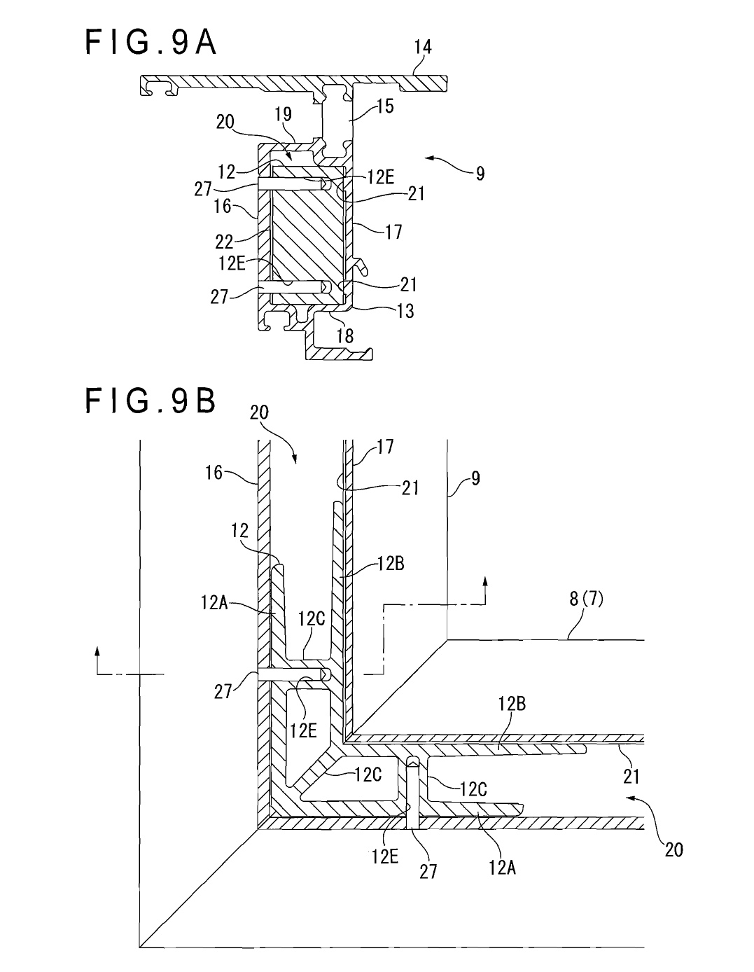

Further, in the present invention, the joint construction that engages the jointed portion (the frame member) with the joint (the joint block) is not limited to the one by cramping described in the above embodiment but may be the one by pinning as shown in the following FIGS. 9A and 9B.

Specifically, in the joint construction shown in FIGS. 9A and 9B, a pin receiving hole 12E is formed on the outside piece 12A of the joint block 12 inserted in the hollow portion 20 of the frame members (the top rail 7, the bottom rail 8, the vertical rails 9). A pin 27 driven from outside of the first opposed piece 16 of the frame members is press-fitted in the pin receiving hole 12E. Then, the pin 27 is driven into the pin receiving hole 12E passing through the first opposed piece 16 so that the first opposed piece 16 is engaged with the joint block 12, which restricts the relative movement between the frame members and the joint block 12. The frame members are consequently fitted with each other.

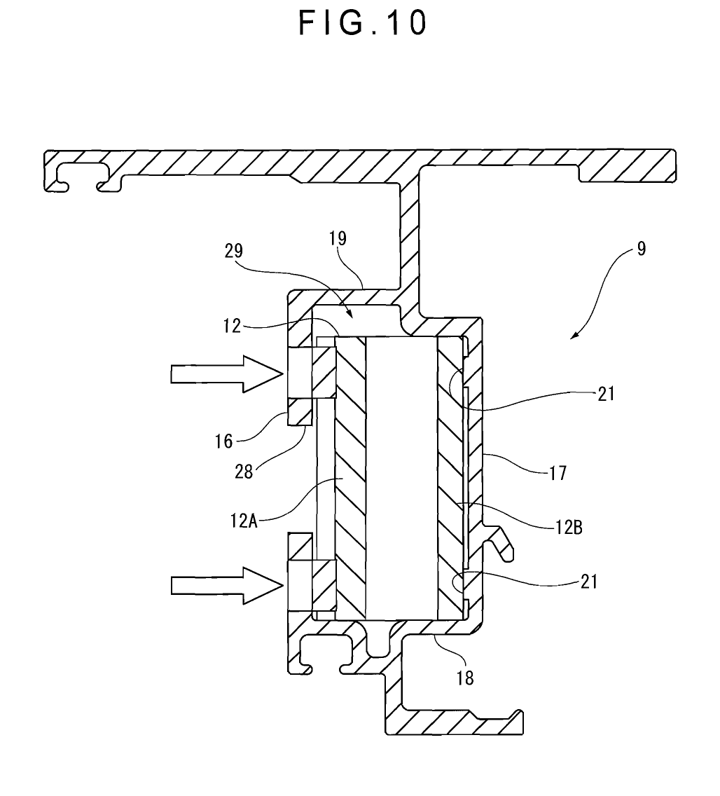

Although the frame members (the top rail 7, the bottom rail 8, the vertical rails 9) include the hollow portion 20 in the above embodiment, as shown in the following FIG. 10, the frame members (the top rail 7, the bottom rail 8, the vertical rails 9) may also be formed in an open cross-section without the hollow portion 20. In other words, the frame members (the vertical rails 9) shown in FIG. 10 has an open cross-section of substantial C-shape where an opening 28 is formed on the first opposed piece 16. The joint block 12 is inserted in an open cross-section inside 29 of this open cross-section. The opening 28 may be formed on, not limited to the first opposed piece 16, the second opposed piece 17 and the width pieces 18, 19.

Further, although the frame members (the top rail 7, the bottom rail 8, the vertical rails 9) include the interior member 13 made from aluminum, the exterior member 14 made from aluminum and the resin-made heat insulating member 15 that connects the interior member 13 and the exterior member 14 in the above embodiment, as shown in FIG. 10, the rail members may be an integrated molding made from aluminum.

Although the best arrangement and method for implementing the present invention has been disclosed above, the present invention is not limited thereto. In other words, while the invention has been mainly illustrated and described on the specific exemplary embodiments, a person skilled in the art can modify the arrangements such as shape, material, quantity and the like of the above-described exemplary embodiments without departing from the technical idea and scope of the invention.

Therefore, the description limiting the shapes, the materials and the like disclosed above is intended to be illustrative for easier understanding but not to limit the invention. Hence the invention includes the description using a name of component without a part of or all of the limitation on the shape, the material and the like.

The priority application Number JP 2007-057662 upon which this patent application is based is hereby incorporated by reference.

What is claimed is:

1. A joint construction that joints jointed portions with each other by engaging a pair of the jointed portions with a joint bridging the pair of the jointed portions, wherein
each of the pair of the jointed portions includes at least a first opposed piece and a second opposed piece which oppose with each other sandwiching the joint, the first opposed piece is engaged with the joint to face the second opposed piece and
at least one of an inner surface of the second opposed piece and an outer surface of the joint which is opposed to the inner surface is provided with a projection that projects towards the other.

2. The joint construction according to claim 1, wherein
the pair of the jointed portions is a pair of elongated frame members jointed with each other by a predetermined crossing angle and
the frame members comprise a hollow portion or an open cross-section whose two sides are formed by the first opposed piece and the second opposed piece, the joint being inserted to the hollow portion or the open cross-section.

3. The joint construction according to claim 2, wherein
the projection is constituted by at least one projected tread formed along a longitudinal direction of the frame member.

4. The joint construction according to claim 3, wherein
the number of the projected tread is one and
a position where the first opposed piece is engaged with the joint is, on a cross section orthogonally crossing the longitudinal direction of the frame member, any one of:
a single first position substantially opposed to the projected tread,
two positions equidistant from each other sandwiching the first position that is opposed to the projected tread and
three positions comprising the first position substantially opposed to the projected tread and the two positions equidistant from each other sandwiching the first position.

5. The joint construction according to claim 3, wherein
two projected treads are provided and
the first opposed piece is engaged with the joint at, on a cross section orthogonally crossing the longitudinal direction of the frame member, any one of:
a single first position opposed to a substantially middle position of the two projected treads,
two positions respectively opposed to the two projected treads and
three positions comprising the two positions respectively substantially opposed to the two projected treads and the first position opposed to the substantially middle position of the two projected treads.

6. The joint construction according to claim 3, wherein
three projected treads are provided and
the first opposed piece is engaged with the joint at, on a cross section orthogonally crossing the longitudinal direction of the frame member, any one of:
two positions respectively opposed to substantially middle positions of two neighboring projected treads of the three projected treads and
three positions respectively opposed to the three projected treads.

7. A fitting, comprising: a frame body assembled by jointing the frame members with each other by the joint construction according to claim 2; and a surface member supported inside the frame body, wherein
the first opposed piece on the frame member is placed on an outside of a width direction with respect to the second opposed piece.

8. A manufacturing method of a fitting that comprises a frame body assembled by jointing a plurality of frame members with each other and a surface member supported inside the frame body, the method comprising:
forming the frame members in a rectangular shape, the frame members comprising at least a first opposed piece and a second opposed piece opposed to each other,
providing a joint which can be inserted between the first opposed piece and the second opposed piece bridging the frame members,
providing a projection on at least any one of an inner surface of the second opposed piece and an outer surface of the joint which is opposed to the inner surface, the projection projecting towards the other,
abutting distal ends of a pair of the frame members with each other while the joint is placed bridging the pair of the frame members jointed with each other, and
abutting the projection to the other of the inner surface of the second opposed piece and the outer surface of the joint so as to joint the pair of the frame members with each other while engaging the first opposed piece with the joint to oppose to the second opposed piece.
